(19) United States
(12) Patent Application Publication
(10) Pub. No.: US 2010/0172310 A1
(43) Pub. Date: Jul. 8, 2010

(54) METHOD TO IMPROVE MOBILE STATION RECEPTION OF DOWNLINK TRANSMISSION FROM A NON-SERVING CELL

(76) Inventors: Fang-Chen Cheng, Randolph, NJ (US); Said Tatesh, Swindon (GB)

Correspondence Address: CARLSON, GASKEY & OLDS, P.C./Alcatel-Lucent, 400 W MAPLE RD, SUITE 350, BIRMINGHAM, MI, 48009, US

(21) Appl. No.: 12/641,479

(22) Filed: Dec. 18, 2009

Related U.S. Application Data
(60) Provisional application No. 61/204,512, filed on Jan. 6, 2009.

(51) Int. Cl. H04W 72/00

(52) U.S. Cl. 370/329

(57) ABSTRACT

An exemplary method of communicating includes using coordinated scheduling of downlink transmissions in a plurality of cells. The coordinated scheduling includes a serving node in one of the cells currently serving a mobile station pausing downlink transmission on at least one selected resource when a non-serving node in a neighboring one of the cells not currently serving the mobile station transmits a downlink communication intended for the mobile station on the selected resource.

### CROSS-REFERENCE TO RELATED APPLICATIONS

This application claims priority to U.S. Provisional Application Ser. No. 61/204,512, which was filed on Jan. 6, 2009.

### FIELD OF THE INVENTION

This invention generally relates to communication. More particularly, this invention relates to wireless communication.

### DESCRIPTION OF THE RELATED ART

Wireless communication systems have increased in popularity and capability. More features are being added to wireless communication systems on a routine basis. One aspect of wireless communications that remains a challenge is accurately locating a mobile station when global positioning system (GPS) signals are not available. There are situations in which a mobile station having GPS capability is not able to detect enough satellite signals for making an accurate location determination. This is particularly true when a mobile station is being used indoors.

One approach proposed for locating mobile stations that does not rely upon GPS signals includes triangulating based upon multiple base station signals received by a mobile station. There are limitations to this technique in that there are many locations where a mobile station is not able to detect enough base stations. Additionally, signals from a base station in another cell are often not reliably received by a mobile station.

### SUMMARY

An exemplary method of communicating includes using coordinated scheduling of downlink transmissions in a plurality of cells. The coordinated scheduling includes a serving node in one of the cells currently serving a mobile station pausing downlink transmission on at least one selected resource when a non-serving node in a neighboring one of the cells not currently serving the mobile station transmits a downlink communication intended for the mobile station on the selected resource.

An exemplary communication system includes a serving node in a cell that is currently serving a mobile station. The serving node pauses downlink transmissions to the mobile station on at least one selected resource when a non-serving node in a neighboring cell transmits a downlink communication intended for receipt by the mobile station on the selected resource.

The various features and advantages of the disclosed example will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of an example communication system.

FIG. 2 is a flowchart diagram summarizing an example approach.

FIG. 3 is a flowchart diagram summarizing an example feature of one example embodiment.

FIG. 4 schematically illustrates a resource block allocation to provide coordinated scheduling of downlink transmissions that is useful with an example embodiment.

### DETAILED DESCRIPTION

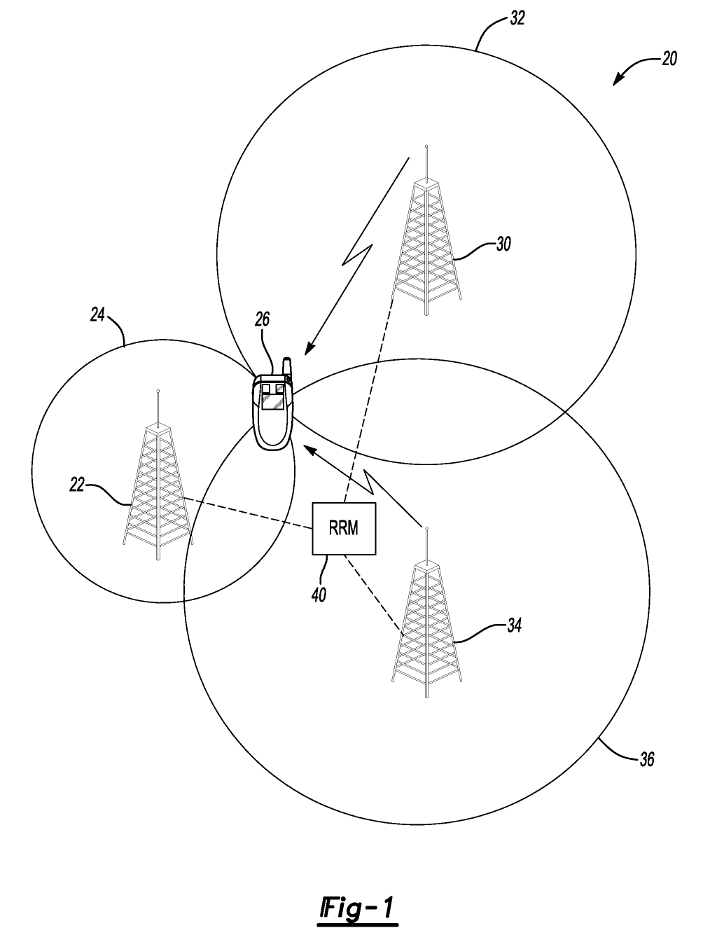

FIG. 1 schematically shows selected portions of an example wireless communication system 20 involved in mobile station positioning using a triangulation technique. One particular communication arrangement that is well suited for the example approach is the LTE Rel-9 communication system. The disclosed example technique is not necessarily limited to any particular wireless communication system arrangement. A base station or node (e.g., eNode B) 22 provides wireless communication service within a cell 24. In the example of FIG. 1, the node 22 serves a mobile station 26. In other words, the cell 24 is the serving cell for the mobile station 26.

The example system includes a non-serving node or base station 30 in a neighboring cell 32. Another non-serving node or base station 34 is in another neighboring cell 36. Given the current location of the mobile station 26, for example, it is capable of detecting downlink transmissions from the nodes 30 and 34.

When it is desirable to determine location information regarding the mobile station 26, it is possible to estimate a distance relative to each base station using downlink transmissions from the nodes 22, 30 and 34 received by the mobile station 26 for that purpose. Known time difference of arrival techniques allow for using known triangulation techniques to determine a location of the mobile station 26. One example situation in which such location information is desirable is if an emergency service (i.e., E911) call is placed from the mobile station 26. Providing proper response to an emergency service call requires determining the location of the caller. Location information may be needed or desired in other situations, also.

The example of FIG. 1 includes a radio resource management (RRM) module 40 that coordinates scheduling of downlink transmissions from the nodes 22, 30 and 34 to increase the ability of the mobile station 26 to receive reliable signals from the non-serving nodes 30 and 34. Given that the node 22 is currently serving the mobile station 26, any transmissions from that node will interfere with the ability of the mobile station 26 to detect signals from the non-serving nodes 30 and 34. The RRM module 40 coordinates timing of transmissions from the nodes on at least one selected resource to increase the ability of the mobile station 26 to reliably receive downlink transmission from each of the nodes so that an accurate location determination can be made.

For purposes of discussion, a single RRM module 40 is schematically shown in FIG. 1. Depending on the arrangement of the particular communication system, each node is likely to have its own RRM functionality that is capable of communicating with the RRM functionality of the other nodes in adjacent or nearby cells. This is true in LTE systems, for example. In some examples there may be a centralized or regional RRM functionality that performs the task of coordinating the scheduling among the serving cell and the neighboring cells. Given this description, those skilled in the art will realize what type of controllers and functionality will best meet the needs of their particular situation.

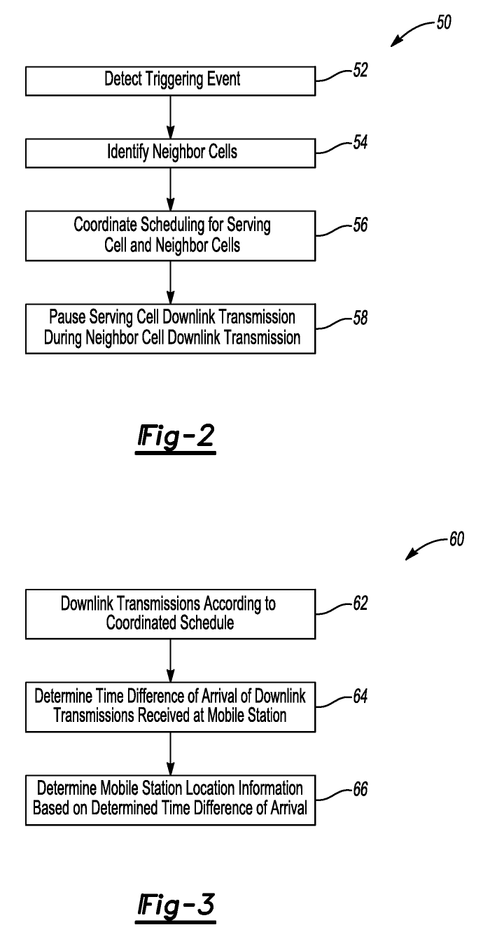

FIG. 2 includes a flowchart diagram 50 that summarizes one example approach. At 52, a triggering event is detected. One example triggering event is an emergency service call from the mobile station 26. Other requests for making a location determination are used as a triggering event in some examples. At 54, neighboring cells are identified. The neighboring cells will be non-serving cells that the mobile station 26 may detect a downlink transmission from given its current disposition. In one example, the mobile station 26 reports a list of neighboring cells to the serving node 22. This information is used by the radio resource management module 40 to coordinate scheduling for the serving cell in the neighbor cells as shown at 56 in FIG. 2.

As shown at 58, the serving cell node 22 will pause or mute downlink transmission to the mobile station 26 over at least one selected resource during an interval during which at least one of the neighbor cell nodes 30, 34 is transmitting a downlink communication intended for the mobile station 26 over the selected resource. Pausing downlink transmission from the serving cell 24 eliminates a source of interference that would otherwise reduce the likelihood that the mobile station 26 would reliably receive a signal from a non-serving node. Increasing the ability of the mobile station 26 to receive downlink transmissions from the non-serving neighbor cells 32 and 36 increases the likelihood of accurately making a location determination regarding the current position of the mobile station 26.

FIG. 3 includes a flowchart diagram 60 that summarizes an example approach for using coordinated downlink transmissions. This example is useful for locating a mobile station based on the downlink transmissions according to coordinated scheduling. At 62, the downlink transmissions occur according to the coordinated schedule. Transmissions from the serving node 22 are paused or muted at a selected resource during a downlink transmission from either of the non-serving nodes 30 and 34 at the selected resource. At 64, a time difference of arrival of the downlink transmissions received at the mobile station 26 is determined. The time difference of arrival information can be determined in a known manner. Given that the scheduling of the downlink transmissions is coordinated, there will be known time offset information between the different transmissions. Such time offset information is incorporated into the algorithm that determines the time difference of arrival information in one example. At 66, mobile station location information is determined based upon the time difference of arrival information for the downlink transmissions from the serving node 22 and the non-serving nodes 30 and 34, respectively. The coordinated scheduling of those downlink transmissions facilitates better reception by the mobile station 26 of each of those transmissions.

One example includes utilizing a special location service reference signal (LCS-RS) for the time difference of arrival measurements. Using a custom or dedicated signal for such purposes can facilitate recognition by a mobile station.

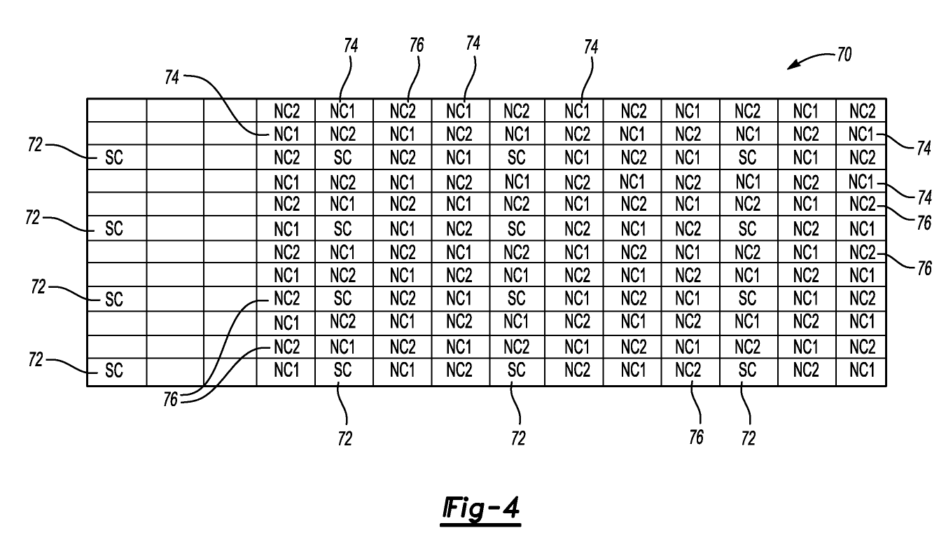

In one example implementation, the coordinated scheduling is based upon resource block allocation. It is desirable to minimize the amount of wireless communication resources that are jointly allocated among the nodes involved in the coordinated scheduling of downlink transmissions to a mobile station about which location information is desired. FIG. 4 schematically shows an example resource block 70 that is utilized for coordinated scheduling of downlink transmissions among a serving cell (SC), a non-serving or neighboring cell (NC1) and another non-serving or neighboring cell (NC2). The resource block 70 is divided into a plurality of subcarriers represented by the rows and each of the subcarriers is divided up into a plurality of time slots represented by the columns.

As can be appreciated from the illustration, some of the subcarriers are used for downlink transmissions 72 from the serving cell and those are labeled “SC” in the drawing. Transmissions from the non-serving cells also occur on the same subcarriers during different time intervals. All downlink transmissions from one of the neighboring cells NC1 occur as shown at 74 and all downlink transmissions from the other neighboring cell NC2 occur at 76. As can be appreciated from the illustration, the serving cell transmissions SC do not occur on the same subcarrier at the same time as a downlink transmission from either of the non-serving cells on that subcarrier. Downlink transmissions from the serving cell to the mobile station 26 on a subcarrier are muted or paused during an interval including a downlink transmission from one of the non-serving cells on that subcarrier.

A resource block allocation as shown in FIG. 4 is useful in an example where each of the nodes 22, 30 and 34 has two transmit antennas. The illustrated example is also useful for minimizing the number of resource blocks that are required for providing downlink transmissions to the mobile station 26 for the determination of location information. Minimizing the number of resource blocks allocated to the location determinations better utilizes overall wireless communication resources. A single resource block that is jointly allocated among the nodes involved in the location determination is useful for some examples.

The arrangement of FIG. 4 also includes a known pattern of transmission from the neighboring cells. This facilitates correctly estimating the timing offset information among the different signals received by the mobile station 26.

One feature of the example of FIG. 4 is that the LCS-RS pattern reuses the resource elements. For example, the different sub-carriers are reused by selected cells for their LCS-RS transmissions. The same resource element is transmitted at some remote cells to have no interference to those cells. This increases the likelihood that the intended recipient will receive the transmission from the remote cell and ensures sufficiently high resource utilization. Additionally, reusing the resources in this manner decreases the required resolution of LCS-RS detection.

In one example the amount of resource element reuse is less than that shown in the example of FIG. 4. One such example includes power boosting the transmission of the LCS-RS from the non-serving cells (compared to the transmit power used for transmissions to mobile stations served by such cells) to increase the likelihood that the LCS-RS signal will be received.

The illustration of FIG. 4 is one example of coordinated scheduling among a serving cell and non-serving cells for making location determinations. When a mobile station reports more than two neighboring cells, a different pattern for providing an LCS-RS to the mobile station may be utilized. Those skilled in the art who have the benefit of this description will be able to determine how best to coordinate scheduling among the involved nodes by utilizing, for example, resource block allocations so that the serving cell downlink transmissions are muted or paused to avoid interfering with a non-serving cell transmission.

FIG. 4 shows one resource allocation technique that coordinates scheduling and assignment of resource elements such as sub-carriers and time slots. Other examples utilize other resource configurations (e.g., carrier frequencies, time frames, etc.) within the coordinated scheduling approach.

Given this description, those skilled in the art will realize that the example approach may be useful for facilitating communications from a non-serving cell to a mobile station even when the mobile station is not involved in a handoff to that non-serving cell. The mobile station may receive and utilize downlink transmissions from a non-serving cell for a variety of purposes such as locating the mobile station.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of communicating, comprising:
using coordinated scheduling of downlink transmissions in a plurality of cells, the coordinated scheduling including a serving node in one of the cells currently serving a mobile station pausing downlink transmission at a selected resource during an interval when a non-serving node in a neighboring one of the cells not currently serving the mobile station transmits a downlink communication intended for the mobile station at the selected resource.

2. The method of claim 1, comprising
the serving node pausing downlink transmission at the selected resource when a second non-serving node in another one of the cells not currently serving the mobile station transmits a downlink communication intended for the mobile station at the selected resource.

3. The method of claim 2, wherein the downlink transmission from the second non-serving node is non-overlapping with the downlink transmission of the non-serving node.

4. The method of claim 1, comprising
determining when a triggering event happens; and
implementing the coordinated scheduling responsive to the triggering event.

5. The method of claim 4, wherein the triggering event comprises a need to determine location information of the mobile station and the downlink transmissions facilitate determining the location information.

6. The method of claim 5, wherein the triggering event comprises an emergency service call from the mobile station.

7. The method of claim 5, comprising
receiving the downlink transmissions at least from each of the node of the serving cell, the non-serving node and at least one other non-serving node;
determining a time difference of arrival of the received transmissions; and
determining an indication of a location of the mobile station based on the determined time difference of arrival.

8. The method of claim 1, comprising
determining which of the cells are neighboring cells to the serving cell; and
using the coordinated scheduling in at least two of the determined neighboring cells and the serving cell.

9. The method of claim 8, comprising
the mobile station reporting a list of the neighboring cells.

10. The method of claim 1, comprising
allocating a resource block to the nodes that use the coordinated scheduling, the resource block comprising a plurality of subcarriers;
scheduling downlink transmissions from the serving node on some of the subcarriers; and
scheduling downlink transmissions from the non-serving node on others of the subcarriers and wherein there are a plurality of the non-serving nodes, each using a different set of the subcarriers.

11. The method of claim 10, comprising
scheduling the downlink transmissions from the serving node on the some of the subcarriers during selected time slots; and
scheduling the downlink transmissions from the non-serving node on the some of the subcarriers during other selected time slots.

12. The method of claim 10, comprising reusing the others of the subcarriers for repeating the downlink transmissions from the non-serving node.

13. The method of claim 1, comprising
using a selected transmit power for downlink transmissions from the non-serving node to intended recipients in the cell of the non-serving node; and
boosting the transmit power used by the non-serving node above the selected transmit power when transmitting the downlink communication intended for the mobile station.

14. The method of claim 1, wherein the downlink transmissions comprise a location service reference signal.

15. A communication system, comprising
a serving node in a cell that is currently serving a mobile station;
a non-serving node in a neighboring cell, the serving node pausing downlink transmissions to the mobile station at a selected resource when the non-serving cell transmits a downlink communication intended for receipt by the mobile station at the selected resource.

16. The system of claim 15, comprising
a resource management module that allocates a common resource to the serving node and the non-serving node and coordinates scheduling of the downlink transmissions of the serving node and the non-serving node.

17. The system of claim 16, wherein
the serving node receives a communication from the mobile station that is a trigger for the coordinated scheduling; and
the resource management module responds to the trigger by allocating the common resource and coordinating the scheduling of the downlink transmissions.

18. The system of claim 17, wherein the communication from the mobile station corresponds to a need to determine location information regarding a location of the mobile station.

19. The system of claim 15, wherein the selected resource comprises at least one time slot on a sub-carrier of a resource block.

20. The system of claim 15, wherein the downlink transmission from the non-serving node is repeated at the selected resource.
